(19) United States
(12) Patent Application Publication
(10) Pub. No.: US 2025/0385737 A1
(43) Pub. Date: Dec. 18, 2025

(54) ACTIVE OPTICAL CABLE, OPTICAL COMMUNICATION NETWORK AND OPTICAL COMMUNICATION METHOD

(71) Applicant: CLOUD INTELLIGENCE ASSETS HOLDING (SINGAPORE) PRIVATE LIMITED, Singapore (SG)

(72) Inventors: Chongjin XIE, Hangzhou, Zhejiang (CN); Anbin WANG, Hangzhou, Zhejiang (CN); Rui LU, Hangzhou, Zhejiang (CN)

(21) Appl. No.: 18/879,699

(22) PCT Filed: Jun. 28, 2023
(86) PCT No.: PCT/CN2023/103102

§ 371 Date: Dec. 27, 2024

(30) Foreign Application Priority Data
Jun. 29, 2022 (CN) 202210751233.X

(51) Int. Cl. H04B 10/40

(52) U.S. Cl. CPC H04B 10/40

(57) ABSTRACT

Embodiments of the present specification provide an active optical cable, an optical communication network and an optical communication method, where according to different connection requirements of a server node and a switch node, the active optical cable is set with optical transceiving apparatuses based on different signal processing technologies at two ends of an optical communication medium, i.e., a first optical transceiving apparatus and a second optical transceiving apparatus. Considering that a network card of the server node is small and signal integrity is easy to ensure, therefore, a signal processing technology used by the first optical transceiving apparatus connected to the server node does not include a digital signal processing technology with high power consumption and cost (i.e., a non-digital signal processing technology), so that the active optical cable reduces the cost and the power consumption of the active optical cable while meeting respective signal integrity requirements of the server node and the switch node.

### CROSS-REFERENCE TO RELATED APPLICATIONS

This application is a National Stage of International Application No. PCT/CN2023/103102, and filed on Jun. 28, 2023, which claims priority to Chinese Patent Application No. 202210751233.X, filed to the China National Intellectual Property Administration on Jun. 29, 2022 and entitled “ACTIVE OPTICAL CABLE, OPTICAL COMMUNICATION NETWORK AND OPTICAL COMMUNICATION METHOD”. The disclosures of the aforementioned applications are hereby incorporated by reference in their entireties.

### TECHNICAL FIELD

The present specification relates to the technical field of a server and, in particular, to an active optical cable, an optical communication network and an optical communication method.

### BACKGROUND

An optical communication technology is widely applied in a data center and other application scenarios due to its advantages such as fast transmission rate and large transmission capacity.

Taking the application scenario of data center as an example, a data center network connects a large number of servers to work together to form a powerful super computer. In the data center network, a server node and a switch node need to be connected by a communication device to perform data exchange. At present, the connection between the server node and the switch node mostly uses direct attach copper cables (DAC). With the increase of data transmission rate between nodes, a transmission distance supported by the direct contact copper cables is continually decreasing, if the distance between two nodes is long due to cross-rack and other reasons, it is difficult to meet connection requirements by the direct contact copper cables. Therefore, an optics to Server (Optical Fiber to Server) technology came into being, the optics to server technology refers to a technology of connecting the server node and the switch node by an optical interconnection technology. Usually, an active optical cable (AOC) can be used as a data communication medium of the server node and the switch node.

At present, it is necessary to optimize the optical interconnection technology to reduce cost and power consumption of connecting the server node and the switch node by the optical interconnection technology.

### SUMMARY

Embodiments of the present specification provide an active optical cable, an optical communication network and an optical communication method. The active optical cable installs optical transceiving apparatuses based on different signal processing technologies at two ends of an optical communication medium according to different connection requirements of a server node and a switch node, and a signal processing technology used by a first optical transceiving apparatus connected to the server node includes a non-digital signal processing technology, so as to achieve purposes of reducing the power consumption and the cost of the active optical cable itself.

In order to achieve the above technical purposes, the embodiments of the specification provide the following technical solutions.

In a first aspect, an embodiment of the present specification provides an active optical cable, applied to an optical communication network, where the optical communication network includes a server node and a switch node, and the active optical cable includes:
an optical communication medium;
a first optical transceiving apparatus and a second optical transceiving apparatus respectively connected at two ends of the optical communication medium, where the first optical transceiving apparatus is configured to connect to the server node, and the second optical transceiving apparatus is configured to connect to the switch node;
where the first optical transceiving apparatus and the second optical transceiving apparatus use different signal processing technologies to perform a transceiving process on a photoelectric signal, and a signal processing technology used by the first optical transceiving apparatus includes a non-digital signal processing technology.

In a second aspect, an embodiment of the present specification provides an active optical cable, applied to an optical communication network, where the optical communication network includes a server node and a switch node, the switch node includes an optical module, and the active optical cable includes:
an optical communication medium;
an optical fiber connector and a third optical transceiving apparatus respectively connected at two ends of the optical communication medium, where the optical fiber connector is configured to connect to the optical module, and the third optical transceiving apparatus is configured to connect to the server node;
the optical fiber connector is configured to perform an optical signal transceiving process for the switch node;
the third optical transceiving apparatus is configured to perform a transceiving process on a third photoelectric signal by using a non-digital signal processing technology.

In a third aspect, an embodiment of the present specification provides an active optical cable, applied to an optical communication network, where the optical communication network includes a server node and a switch node, and the active optical cable includes:
an optical communication medium;
a fourth optical transceiving apparatus and a fifth optical transceiving apparatus respectively connected at two ends of the optical communication medium, where the fourth optical transceiving apparatus is configured to connect to the server node, and the fifth optical transceiving apparatus is configured to connect to the switch node;
where the fourth optical transceiving apparatus and the fifth optical transceiving apparatus are different types of optical transceiving apparatuses, and a power consumption of the fourth optical transceiving apparatus is less than a power consumption of the fifth optical transceiving apparatus.

In a fourth aspect, an embodiment of the present specification provides an optical communication network which includes a plurality of node devices, where the node devices are connected through active optical cables, and the node devices are server nodes or network switching device nodes, and the network switching device nodes include a switch node;
where the active optical cable is the active optical cable described in any one of the above.

In a fifth aspect, an embodiment of the present specification provides an optical communication method, including:
acquiring a first signal to be sent transmitted by a switch node;
converting, by using a first signal processing technology, the first signal to be sent into an optical signal for transmission;
acquiring a second signal to be sent transmitted by a server node;
converting, by using a second signal processing technology, the second signal to be sent into an optical signal for transmission, where the first signal processing technology is different from the second signal processing technology, and the second signal processing technology includes a non-digital signal processing technology.

It can be seen from the above technical solutions that the embodiments of the present specification provide an active optical cable, an optical communication network and an optical communication method, where according to different connection requirements of a server node and a switch node, the active optical cable is set with optical transceiving apparatuses based on different signal processing technologies at two ends of an optical communication medium, i.e., a first optical transceiving apparatus and a second optical transceiving apparatus. Considering that a network card of the server node is small and signal integrity is easy to ensure, therefore, a signal processing technology used by the first optical transceiving apparatus connected to the server node does not include a digital signal processing technology with high power consumption and cost (i.e., including a non-digital signal processing technology), so that the active optical cable reduces the cost and the power consumption of the active optical cable while meeting respective signal integrity requirements of the server node and the switch node.

### BRIEF DESCRIPTION OF DRAWINGS

In order to more clearly illustrate technical solutions of embodiments of the present specification or the prior art, the drawings needed to be used in the description of the embodiments or the prior art will be briefly introduced below. Obviously, the drawings in the following description are some embodiments of the present specification, and for those of ordinary skill in the art, other drawings may be obtained according to these drawings without paying creative efforts.

FIG. 1 is a schematic diagram of an implementation environment of an active optical cable provided by an embodiment of the present specification.

FIG. 2 is a schematic structural diagram of an active optical cable provided by an embodiment of the present specification.

FIG. 3 is a schematic structural diagram of another active optical cable provided by an embodiment of the present specification.

FIG. 4 is a schematic structural diagram of yet another active optical cable provided by an embodiment of the present specification.

FIG. 5 is a schematic structural diagram of yet still another active optical cable provided by an embodiment of the present specification.

FIG. 6 is a schematic structural diagram of an active optical cable provided by another embodiment of the present specification.

FIG. 7 is a schematic structural diagram of another active optical cable provided by another embodiment of the present specification.

FIG. 8 is a schematic structural diagram of yet another active optical cable provided by another embodiment of the present specification.

FIG. 9 is a schematic structural diagram of yet still another active optical cable provided by another embodiment of the present specification.

FIG. 10 is a schematic structural diagram of an active optical cable provided by yet another embodiment of the present specification.

FIG. 11 is a schematic structural diagram of another active optical cable provided by yet another embodiment of the present specification.

FIG. 12 is a schematic structural diagram of yet another active optical cable provided by yet another embodiment of the present specification.

FIG. 13 is a schematic structural diagram of an optical communication network provided by an embodiment of the present specification.

FIG. 14 is a flowchart of an optical communication method provided by an embodiment of the present specification.

### DESCRIPTION OF EMBODIMENTS

Unless otherwise defined, technical terms or scientific terms used in embodiments of the present specification shall have ordinary meanings as understood by those of ordinary skill in the art to which the present specification belongs. Words “first”, “second” and similar words used in the embodiments of the present specification do not indicate any order, quantity or importance, but are only used to avoid confusion of constituent elements.

Unless the context requires otherwise, in the whole specification, “a plurality of” represents “at least two”, and “include” is interpreted as an opening and containing meaning, that is, “containing but not limited to”. In the description of the specification, terms such as “one embodiment”, “some embodiments”, “an exemplary embodiment”, “an example”, “a specific example” or “some examples” are intended to indicate that a specific feature, a structure, a material or a characteristic related to the embodiment or the example is included in at least one embodiment or example of the present specification. The schematic representations of the above terms do not necessarily refer to the same embodiment or example.

In the following, the technical solutions of the embodiments in the present specification will be clearly and comprehensively described in connection with the drawings of the embodiments in the present specification. Obviously, the described embodiments are part of embodiments of the present specification, rather than all embodiments. Based on the embodiments in the present specification, all other embodiments obtained by those of ordinary skill in the art without paying creative efforts belong to the protection scope of the present specification.

### Overview of Application

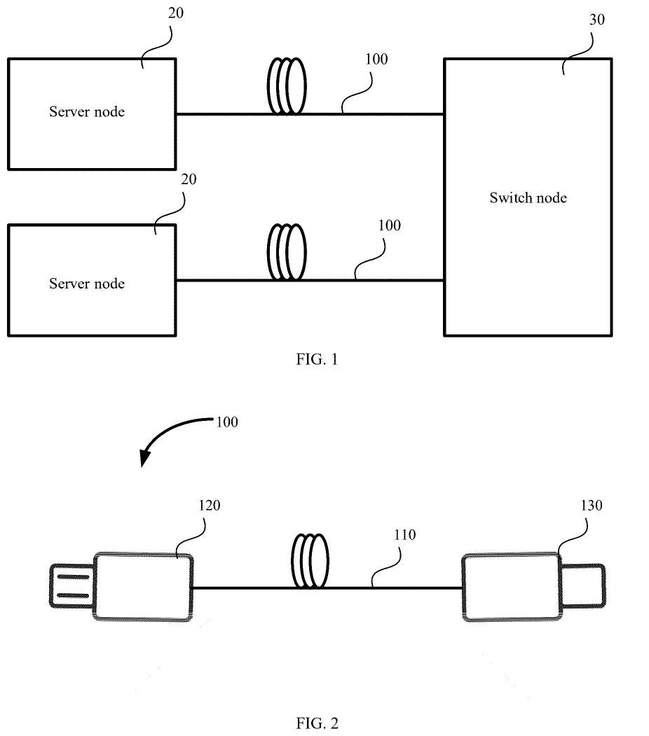

Referring to FIG. 1, FIG. 1 shows a schematic diagram of a possible implementation environment of an active optical cable provided by an embodiment of the present specification. The implementation environment is an optical communication network, and the optical communication network includes server nodes 20, a switch node 30, and an active optical cable 100 for connecting the server nodes 20 and the switch node 30.

A feasible architecture of the switch node 30 could be a TOR (Top of Rack) architecture, an EOR (End of Row) architecture or a MOR (Middle of Row) architecture. A switch node 30 installed in the TOR architecture is called a TOR switch, a switch node 30 installed in the EOR architecture is called an EOR switch, and a switch node 30 installed in the MOR architecture is called a MOR switch. The EOR architecture and the MOR architecture are only slightly different in term of the deployment location, the EOR architecture is equipped a network cabinet (maybe one, also maybe one at the head and one at the end respectively) at an edge of each row of cabinets to provide a unified network access point. A network interface card (NIC) on the server cabinet is connected to a distribution frame of the same cabinet through connecting media such as a network jumper, an AC, an AOC, an optical fiber jumper, etc., and cables on the distribution frame are tied by a cable tie and then through a wiring channel or floors to connect the endmost network cabinet at each row. The MOR architecture is an improvement for the EOR architecture. A main difference is a position of a head cabinet. In the MOR architecture, the head cabinet is placed in the middle of each row of cabinets. A MOR network cabinet is deployed between two rows of cabinets in a pair of cabinets, which can reduce a cable distance from server cabinets to network cabinets and simplify cable management and maintenance. The TOR architecture is an extension for the EOR architecture, the TOR architecture deploys 1-2 access switches on each server cabinet, a server is accessed to the switch in the cabinet by a cable, and an upstream port of the switch is accessed to a convergence switch in the network cabinet by a cable.

In the traditional connecting medium, the DAC is a passive copper cable, which can support a limited bandwidth and distance, and an application range of the DAC can usually be represented by R×L<100 Gb/s.m, where R represents a transmitted signal rate and L is a length of the DAC. For a signal with a rate of 100 GB/s, a transmission distance that the DAC can support is only about 1 meter. With the further increase of a signal rate, the transmission distance that the DAC can support will be further reduced.

A transmission distance of an AEC (Active Electrical Cable) is improved by adding equalizers, such as a power amplifier, a CDR (Clock Data Recovery) or a DSP (Digital Signal Processing) at two ends of the cable. A support distance of the AEC is also very limited, when a signal rate to be transmitted is 50 GB/s or 100 GB/s, a transmission distance that the AEC can support is only 5˜7 meters, at the same time, because the use of active electrical components, the power consumption and the cost are also high.

In view of this, in some application scenarios, the AOC can be used as a data transmission medium of a server node and a switch node. The AOC uses optical transceivers at two ends to perform conversion between an electrical signal and an optical signal, and the optical transceivers at two ends are connected by optical fiber cables. For a high transmission rate signal with the transmission rate of 100 GB/s, a transmission distance that the AOC can support can reach hundreds of meters. However, through researching, the inventor found that the power consumption and the cost of an AOC device are high, which hinders the development of the AOC in a practical application. Especially when a single-channel rate reaches 100 GB/s or above, a complex DSP or CDR technology is usually needed, resulting in high cost and power consumption of the AOC.

After further researching, the inventor found that in the application scenario shown in FIG. 1, a distance from a switch chip to a front panel of the switch in the switch node 30 is comparatively long, and the signal is affected by a bandwidth limitation and other damages (such as reflection, crosstalk, etc.) in a transmission process, so the optical transceiving device connected to one end of the switch node 30 by the AOC needs to use complex and advanced technologies such as a DSP and a CDR to ensure signal integrity. However, the network card of the server node 20 is small, and the signal integrity is easy to ensure, therefore, a simple linear technology or a direct driving technology is used in the optical transceiving apparatus at one end of the server node 20 connected to the AOC to meet signal quality requirements. Based on this, an active optical cable is proposed, where the active optical cable is set with optical transceiving apparatuses based on different signal processing technologies at two ends of an optical communication medium according to different connection requirements of a server node and a switch node, i.e., a first optical transceiving apparatus and a second optical transceiving apparatus. Considering that a network card of the server node is small and signal integrity is easy to be ensured, therefore, a signal processing technology used by the first optical transceiving apparatus connected to the server node does not include a digital signal processing technology (i.e., including a non-digital signal processing technology) with high power consumption and cost, so that the active optical cable can reduce the cost and the power consumption of the active optical cable while meeting the respective signal integrity requirements of the server node and the switch node.

In the following, active optical cables provided by the embodiments of the present specification will be described in combination with feasible exemplary embodiments.

### Exemplary Active Optical Cables

An embodiment of the present specification provides an active optical cable, as shown in FIG. 2, which is applied to an optical communication network, the optical communication network includes a server node and a switch node, and the active optical cable 100 includes the following:
an optical communication medium 110, where the optical communication medium 110 is used for transmitting optical signals; and the optical communication medium 110 refers to a medium that can provide an optical signal communication path, and the optical communication medium 110 could be a structure such as an optical fiber or an optical cable; and
a first optical transceiving apparatus 120 and a second optical transceiving apparatus 130 respectively connected at two ends of the optical communication medium 110, where the first optical transceiving apparatus 120 is used for connecting the server node, and the second optical transceiving apparatus 130 is used for connecting to the switch node.

The first optical transceiving apparatus 120 and the second optical transceiving apparatus 130 use different signal processing technologies to perform a transceiving process on a photoelectric signal, and the signal processing technology used by the first optical transceiving apparatus 120 includes a non-digital signal processing technology.

The first optical transceiving apparatus 120 is used for connecting to the server node, and the first optical transceiving apparatus 120 can be used as a signal conversion and transceiving device of the server node. For example, the first optical transceiving apparatus 120 can convert an electrical signal to an optical signal for a sent signal of the server node, so that the sent signal of the server node can be transmitted to other nodes through the active optical cable 100. The first optical transceiving apparatus 120 can also convert the received optical signal into an electrical signal to meet an optical signal receiving requirement of the server node. In some embodiments, the first optical transceiving apparatus 120 can also provide compensation for a signal transceiving process of the server node, so as to improve the signal quality of the server node transceiving signals.

The second optical transceiving apparatus 130 is used for connecting to the switch node. Similar to the first optical transceiving apparatus 120, the second optical transceiving apparatus 130 can be used as a signal conversion and transceiving device of the switch node.

The difference there between is that the first optical transceiving apparatus 120 and the second optical transceiving apparatus 130 use different signal processing technologies to perform the transceiving process on the photoelectric signal, where the signal processing technologies may be a signal processing technology involved in an optical communication technology, but it is not limited to the optical signal processing technology, and it may also involve an electrical signal processing technology. As mentioned above, since the server node can easily maintain the signal integrity in an optical communication process, therefore, the signal processing technology used by the first optical transceiving apparatus can include a non-digital signal processing technology to reduce the power consumption and cost of the first optical transceiving apparatus, so as to reduce the overall cost of the active optical cable.

At the same time, the second optical transceiving apparatus 130 and the first optical transceiving apparatus 120 use different signal processing technologies, so that the two optical transceiving apparatuses of the active optical cable 100 can meet different requirements of the switch node and the server node, respectively, and reduce the power consumption and cost of the active optical cable on the basis of ensuring the integrity of transceiving signals of the switch node and the server node. In general, it is not difficult to understand that since the signal integrity of the switch node is difficult to maintain in the optical communication process, a signal processing technology used by the second optical transceiving apparatus is usually more advanced and/or complicated than a signal processing technology used by the first optical transceiving apparatus, accordingly, the power consumption and/or cost of the second optical transceiving apparatus is usually higher than the power consumption and/or cost of the first optical transceiving apparatus.

Particularly, in an exemplary embodiment of the present specification, the active optical cable is particularly suitable for an application scenario in which the signal rate for transmission is greater than or equal to 100 GB/s, that is, the optical signal rate transmitted in the active optical cable is greater than or equal to 100 GB/s. In this case, the first optical transceiving apparatus can still use a signal processing technology with lower power consumption and cost (such as a linear amplifier technology or a direct drive technology), which can meet the signal integrity requirements of the server node, and the second optical transceiving apparatus can use a signal processing technology with higher power consumption and cost, such as a digital signal processing technology, to ensure the signal integrity requirements of the switch node. At this time, the cost and power consumption advantages of the active optical cable provided by the embodiment of the present specification can be obviously embodied. Of course, in other embodiments of the present specification, the optical signal rate transmitted in the active optical cable can also be less than 100 GB/s.

Since the signal transceiving process of the first optical transceiving apparatus 120 and the second optical transceiving apparatus 130 usually involves a mutual conversion between optical signals and electrical signals, the signals processed by the first optical transceiving apparatus 120 and the second optical transceiving apparatus 130 by using a signal processing technology are called photoelectric signals.

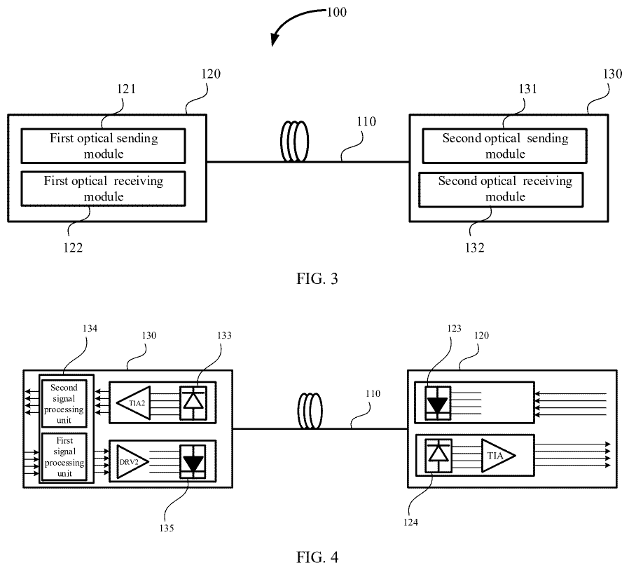

In an exemplary embodiment of the present specification, as shown in FIG. 3, the first optical transceiving apparatus 120 includes a first optical sending module 121 and a first optical receiving module 122; and the second optical transceiving apparatus 130 includes a second optical sending module 131 and a second optical receiving module 132, where the photoelectric signal includes a first photoelectric signal and a second photoelectric signal.

The first optical sending module 121 is configured to perform a sending process on a first signal to be sent by using a first optical sending technology to obtain the first photoelectric signal, where the first optical sending technology includes an optical amplitude modulation technology; and the first signal to be sent is a signal to be sent of the first optical sending module.

In a process of sending the optical signal, the optical amplitude modulation technology refers to a technology of modulating and loading the signal to be sent (for example, the first signal to be sent) onto an optical carrier, the optical carrier can be generated by a device such as a laser in the first optical sending module 121. After the signal to be sent is modulated and loaded onto the optical carrier, the optical carrier carrying the signal to be sent has a condition for transmission through the optical communication medium 110.

The first optical receiving module 122 is configured to perform a receiving process on the second photoelectric signal by using a first optical receiving technology to obtain a first received signal, where the first optical receiving technology includes an electric amplitude demodulation technology.

In a process of receiving the optical signal, the electric amplitude demodulation technology refers to a technology of performing the electric amplitude demodulation on the photoelectric signal after photoelectric conversion (such as the second photoelectric signal) to obtain a required signal. The photoelectric conversion process can be realized by photoelectric detectors such as a PIN photodiode or an avalanche photo diode (APD). In the optical receiving module, after performing the photoelectric conversion and the electric amplitude demodulation for the received optical signal, an electric signal that a communication opposite end would send can be parsed from the optical signal.

The second optical sending module 131 is configured to perform a sending process on a second signal to be sent by using a second optical sending technology to obtain the second photoelectric signal, where the second optical sending technology includes an optical amplitude modulation technology and a first signal compensating technology, and the first signal compensating technology includes a digital signal processing technology and/or a clock data recovery (CDR) technology; and the second signal to be sent is a signal to be sent of the second optical sending module.

The second optical receiving module 132 is configured to perform a receiving process on the first photoelectric signal by using a second optical receiving technology to obtain a second received signal, where the second optical receiving technology includes the electric amplitude demodulation technology and the first signal compensating technology.

The digital signal processing technology can be realized by a digital signal processor or a digital signal processing chip. The clock data recovery technology can be realized by a clock data recovery circuit, and the clock data recovery technology is used to correctly recover a clock and data from data with channel distortion. An optical amplitude modulation technology and an electrical amplitude demodulation technology involved in the second optical sending module 131 and the second optical receiving module 132 are similar to the related parts introduced above, and will not be described in detail here.

In this embodiment, the first optical transceiving apparatus 120 uses the direct drive technology to receive and send an optical signal at the server node. Specifically, referring to FIG. 4, FIG. 4 shows a feasible structure of the first optical transceiving apparatus 120 and the second optical transceiving apparatus 130 when using the direct driving technology.

In the structure shown in FIG. 4, the first optical sending module includes: a first optical modulating unit 123.

The first optical modulating unit 123 is configured to generate a first optical carrier, and modulate and load a first signal to be sent onto the first optical carrier to form an optical signal transmitted by the optical communication medium 110. In an implementation, the first optical modulating unit 123 may be a laser.

The first optical receiving module includes: a first photoelectric conversion unit 124 and a trans-impedance amplifier (TIA), where the first photoelectric conversion unit 124 is configured to perform a photoelectric conversion on a received optical signal to obtain a current signal, and the trans-impedance amplifier TIA is configured to convert the current signal into a voltage signal and perform a low-noise amplification to obtain a required electrical received signal.

The second optical sending module includes: a second optical generating unit 135, a second optical modulating unit and a third signal compensating unit, where the second optical generating unit 135 is configured to generate a second optical carrier, and the second optical modulating unit is configured to modulate and load a second signal to be sent onto the second optical carrier.

The third signal compensating unit includes: a first signal processing unit and a second driving amplifier DRV2, where the second driving amplifier DRV2 is configured to increase the power of the second signal to be sent to improve a modulation efficiency of the second optical carrier, and the first signal processing unit is configured to regenerate and equalize the second signal to be sent based on a digital signal processing technology or a clock data recovery technology.

The second optical receiving module includes: a fourth signal compensating unit. The fourth signal compensating unit includes: a second signal processing unit and a second trans-impedance amplifier TIA2, where the second trans-impedance amplifier TIA2 is configured to perform, for a second input signal, a current-to-voltage conversion and an amplification for the first time, and the second signal processing unit is configured to regenerate and equalize the second input signal after the amplification for the first time based on the digital signal processing technology or the clock data recovery technology. The second input signal is an input signal of the second trans-impedance amplifier.

When the first signal processing unit and the second signal processing unit are based on the same processing technology, the first signal processing unit and the second signal processing unit may be integrated in one signal processing module 134. For example, when both the first signal processing unit and the second signal processing unit are based on the digital signal processing technology, the first signal processing unit and the second signal processing unit can be integrated in a digital signal processor or a digital signal processing chip.

In the embodiment shown in FIG. 4, the first optical transceiving apparatus 120 realizes optical signal transceiving functions of the server node based on the direct driving technology, and has characteristics of low power consumption and low cost and the structure of the first optical transceiving apparatus 120 being simple.

In an exemplary embodiment of the present specification, the first optical sending technology further includes: a second signal compensating technology, and the first optical receiving technology further includes: the second signal compensating technology, where the second signal compensating technology includes a linear amplifying technology and/or a clock data recovery technology.

The first optical transceiving apparatus 120 can not only realize the optical signal transceiving functions of the server node by using the direct driving technology, but also compensate the received-sent signals by using a simple linear amplifying technology and a clock data recovery technology, so that the first optical transceiving apparatus 120 can be applied to more types of server nodes and enhance the applicability of the active optical cable. In an exemplary embodiment of the present specification, the second signal compensating technology may include the linear amplifying technology, may also include the clock data recovery technology, and may also could include both the linear amplifying technology and the clock data recovery technology. When the second signal compensating technology includes both the linear amplifying technology and the clock data recovery technology, the first optical transceiving apparatus 120 could include a plurality of first optical sending modules and a plurality of first optical receiving modules, and the second optical transceiving apparatus 130 may also include a plurality of second optical sending modules 131 and a plurality of second optical receiving modules 132. Referring to FIG. 5, in the first optical transceiving apparatus 120 and the second optical transceiving apparatus 130, based on a wavelength division multiplexing technology, signals can be wavelength-division multiplexed by a wavelength beam splitter/combiner and other devices, and signals of different branches can be processed by using the linear amplifying technology or the clock data recovery technology to meet processing requirements of multi-channel signals.

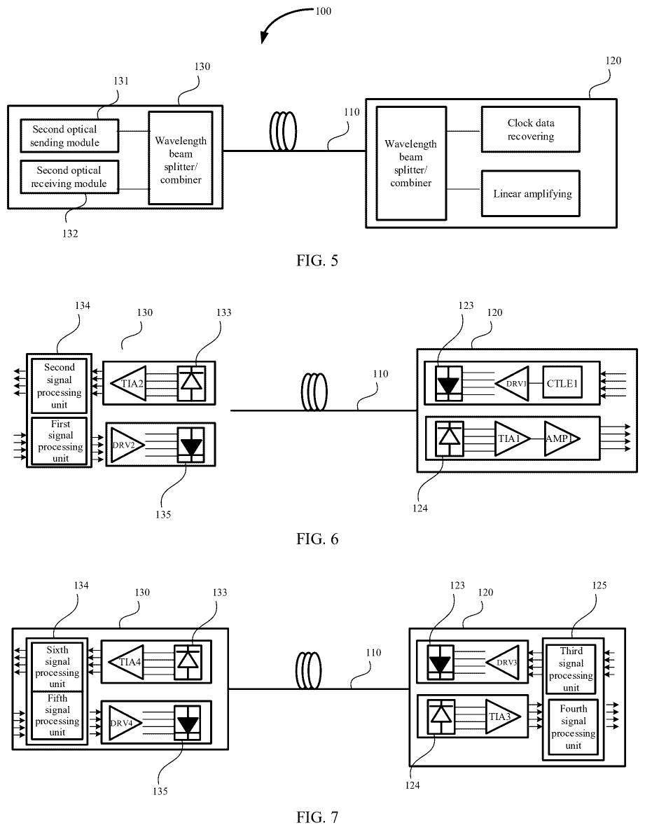

In an exemplary embodiment of the present specification, referring to FIG. 6, the first optical sending module includes: a first signal compensating unit, and the first signal compensating unit includes: a first continuous-time linear equalizer CTLE1 and a first driving amplifier DRV1, where the first continuous-time linear equalizer CTLE1 is configured to compensate a signal distortion of a first signal to be sent, and the first driving amplifier DRV1 is configured to improve power of the first signal to be sent to improve an optical modulation efficiency.

The first optical receiving module includes: a second signal compensating unit, and the second signal compensating unit includes: a first trans-impedance amplifier TIA1 and a first linear amplifier AMP1, where the first trans-impedance amplifier TIA1 is configured to perform, for a first input signal, a current-to-voltage conversion and an amplification for the first time, and the first linear amplifier AMP1 is configured to perform, for the first input signal after the amplification for the first time, an amplification for the second time; and where the first input signal is an input signal of the first trans-impedance amplifier.

The second optical sending module includes: a third signal compensating unit, and the third signal compensating unit includes: a first signal processing unit and a second driving amplifier DRV2, where the second driving amplifier DRV2 is configured to improve power of a second signal to be sent to improve a modulation efficiency of the second optical carrier, and the first signal processing unit is configured to regenerate and equalize the second signal to be sent based on the digital signal processing technology or the clock data recovery technology.

The second optical receiving module includes: a fourth signal compensating unit, and the fourth signal compensating unit includes: a second signal processing unit and a second trans-impedance amplifier TIA2, where the second trans-impedance amplifier TIA2 is configured to perform, for a second input signal, a current-to-voltage conversion and an amplification for the first time, and the second signal processing unit is configured to regenerate and equalize the second input signal after the amplification for the first time based on the digital signal processing technology or the clock data recovery technology, and where the second input signal is an input signal of the second trans-impedance amplifier TIA2.

It can be understood that in this embodiment, differences between the first optical sending module, the first optical receiving module, the second optical sending module as well as the second optical receiving module, and the active optical cable described above are emphatically described. In order to realize basic functions of the active optical cable, the first optical sending module still includes the first optical generating unit 123 and the first optical modulating unit, where the first optical receiving module still includes a first photoelectric conversion unit 124, and the second optical sending module still includes a second optical generating unit 135 and a second optical modulating unit. These modules have been described in the above, and will not be repeated here.

In this embodiment, the first optical transceiving apparatus performs signal compensation based on the linear amplifying technology, which can improve the signal transceiving quality of the server node to a certain extent, so that the active optical cable can be suitable for a general scene of the signal transmission environment of the server node, which is beneficial to improve the applicability of the active optical cable.

In an exemplary embodiment of the present specification, referring to FIG. 7, the first optical sending module includes: a fifth signal compensating unit, and the fifth signal compensating unit includes: a third signal processing unit and a third driving amplifier DRV3, where the third driving amplifier DRV3 is configured to improve power of the first signal to be sent to improve a modulation efficiency of the first optical carrier, and the third signal processing unit is configured to regenerate and equalize the first signal to be sent based on the clock data recovery technology.

The first optical receiving module includes: a sixth signal compensating unit, and the sixth signal compensating unit includes: a fourth signal processing unit and a third trans-impedance amplifier TIA3, where the third trans-impedance amplifier TIA3 is configured to perform, for a third input signal, a current-to-voltage conversion and an amplification for the first time, the fourth signal processing unit is configured to regenerate and equalize the third input signal after the amplification for the first time based on the clock data recovery technology. The third input signal is an input signal of the third trans-impedance amplifier.

The second optical sending module includes: a seventh signal compensating unit, and the seventh signal compensating unit includes: a fifth signal processing unit and a fourth driving amplifier DRV4, where the fourth driving amplifier DRV4 is configured to improve power of a second signal to be sent to improve a modulation efficiency of the second optical carrier, and the fifth signal processing unit is configured to regenerate and equalize the second signal to be sent based on the digital signal processing technology; and where the second signal to be sent is a signal to be sent of the second optical sending module.

The second optical receiving module includes: an eighth signal compensating unit, and the eighth signal compensating unit includes a sixth signal processing unit and a fourth trans-impedance amplifier TIA4, where the fourth trans-impedance amplifier TIA4 is configured to perform, for a fourth input signal, a current-to-voltage conversion and an amplification for the first time, and the sixth signal processing unit is configured to regenerate and equalize the fourth input signal after the amplification for the first time based on the digital signal processing technology, and where the fourth input signal is an input signal of the fourth trans-impedance amplifier.

Similarly, when based on the same signal processing technology, the fifth signal processing unit and the sixth signal processing unit could be integrated in one signal processing module 134. The third signal processing unit and the fourth signal processing unit could be integrated in one signal processing module 125.

In this embodiment, the first optical transceiving apparatus 120 realizes the signal transceiving compensation for the server node based on the clock data recovery technology, so that the active optical cable can be applied in a relatively harsh environment, and the application scene of the active optical cable is improved, and the applicability of the active optical cable is improved.

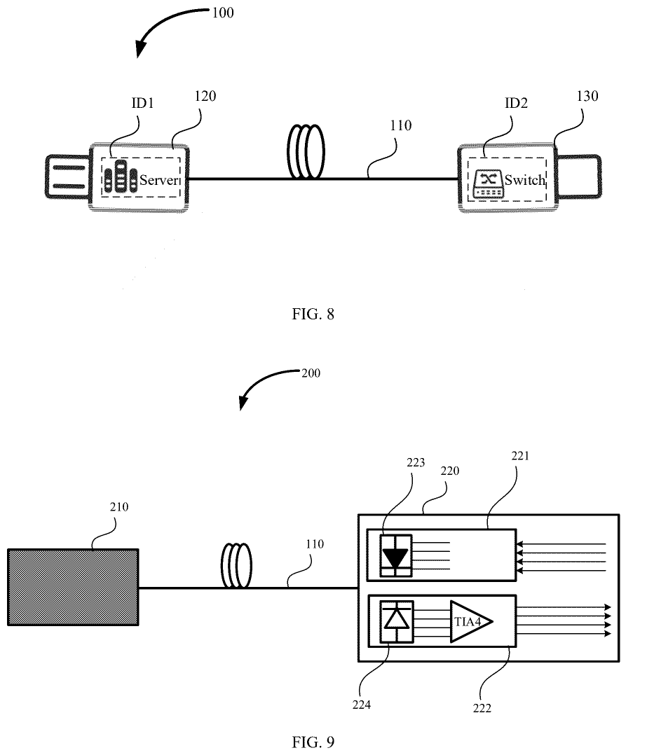

In an exemplary embodiment of the present specification, referring to FIG. 8, the first optical transceiving apparatus 120 further includes: a first identifier ID1, where the first identifier ID1 is used for indicating that the first optical transceiving apparatus 120 is used to connect to the server node.

The second optical transceiving apparatus 130 further includes: a second identifier ID2, where the second identifier ID2 is used for indicating that the second optical transceiving apparatus 130 is used to connect the switch node.

Since the active optical cable provided by the embodiment of the present specification is an active optical cable with an asymmetric structure, optical transceiving apparatuses at two ends thereof (i.e., a first optical transceiving apparatus 120 and a second optical transceiving apparatus 130) are obviously different, and node devices (a server node and a switch node) connected are also different, therefore, a first identifier ID1 and a second identifier ID2 can be set on conspicuous positions of the first optical transceiving apparatus 120 and the second optical transceiving apparatus 130 respectively to represent that node devices to which the first optical transceiving apparatus 120 and the second optical transceiving apparatus 130 can be connected, respectively.

The first identifier IDI could be a Chinese identifier or an English identifier of a server (Server), could also be a pattern identifier of the server (for example, a server icon), and could also be a customized symbol used to characterize the server (for example, A is used to characterize the server), etc. In the embodiment shown in FIG. 8, the first identifier ID1 includes a combination of an English identifier and a pattern identifier of the server (Server).

Accordingly, the second identifier ID2 could be a Chinese identifier or an English identifier of a switch (Switch), could also be a pattern identifier of the switch (for example, a switch icon), and could also be a customized symbol used to characterize the switch (for example, is used to characterize the switch), etc. In the embodiment shown in FIG. 8, the second identifier ID1 includes a combination of an English identifier and a pattern identifier of the switch.

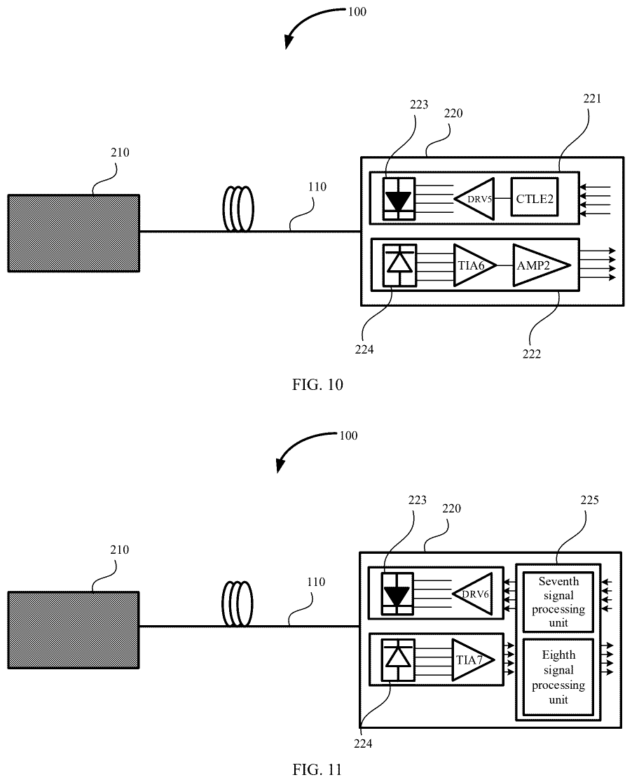

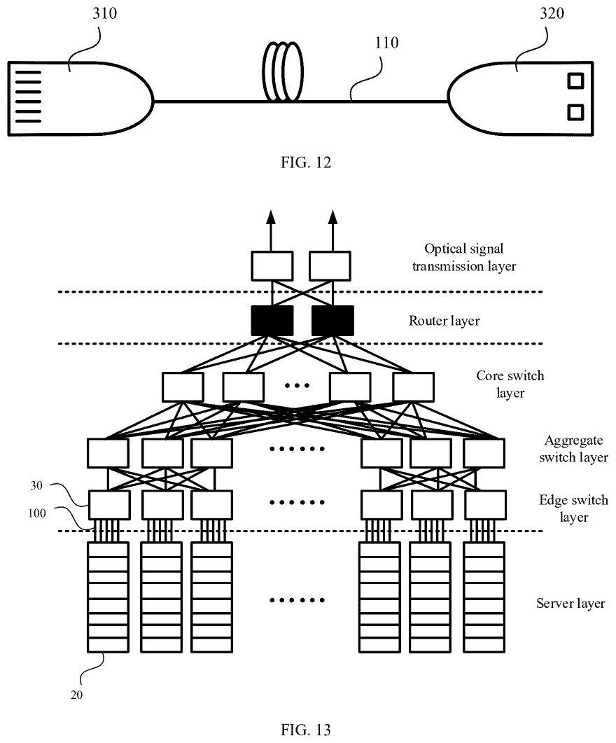

In an implementation, an exemplary embodiment of the present specification further provides an active optical cable. As shown in FIG. 9, FIG. 10 and FIG. 11, the active optical cable 100 is applied to an optical communication network, where the optical communication network includes a server node and a switch node, the switch node includes an optical module, and the active optical cable 100 includes:

an optical communication medium 110, where the optical communication medium 110 is used for transmitting an optical signal;

an optical fiber connector 210 and a third optical transceiving apparatus 220 respectively connected at two ends of the optical communication medium 110, where the optical fiber connector 210 is configured to connect to the optical module, and the third optical transceiving apparatus 220 is configured to connect to the server node.

The optical fiber connector 210 is configured to perform an optical signal transceiving process for the switch node.

The third optical transceiving apparatus 220 is configured to perform a transceiving process on a third photoelectric signal by using a non-digital signal processing technology.

With the continuous development of a packaging technology and an integrated circuit technology, technologies (such as a co-packaged optics (CPO) technology, a near-packaged optics (NPO) technology and an on-board optics (OPO) technology) have emerged to package or integrate optical modules into switch nodes. In order to meet connection and communication requirements of such switch nodes and server nodes, the embodiment of the present specification provides an active optical cable 100 with an optical fiber connector 210, and at the same time, a third optical transceiving apparatus 220 of the active optical cable 100 performs a transceiving process on a third photoelectric signal by using a signal processing technology other than the digital signal processing technology, which is beneficial to reduce the power consumption and cost of the active optical cable 100.

In an implementation, the switch node further includes an integrated circuit (IC) chip, where the integrated circuit chip and the optical module are packaged in the switch node through a co-packaged optics technology, an on-board optics technology or a near-packaged optics technology. The integrated circuit chip includes but is not limited to a network switching chip. Through the co-packaged optics technology, the on-board optics technology or the near-packaged optics technology, the integrated circuit chip and the optical module are packaged in the switch node, which is helpful to reduce a volume of the active optical cable 100 and realize a direct optical signal transmission between the active optical cable 100 and the switch node.

In an implementation, still referring to FIG. 9, the third optical transceiving apparatus 220 includes: a third optical sending module 221 and a third optical receiving module 222.

The third optical sending module 221 is configured to perform a sending process on a third signal to be sent by using a third optical sending technology to obtain a third photoelectric signal, where the third optical sending technology includes an optical amplitude modulation technology, and the third signal to be sent is a signal to be sent of the third optical sending module 221.

The third optical receiving module 222 is configured to perform a receiving process on the third photoelectric signal by using a third optical receiving technology, where the third optical receiving technology includes an electric amplitude demodulation technology.

The third light sending module 221 includes a third light generating unit 223 and a third light modulating unit. Based on the third optical generating unit 223 and the third optical modulating unit, a specific process of sending optical signals by using the optical amplitude modulation technology is similar to the related parts described above (for example, based on the first optical generating unit 123 and the first optical modulating unit, a process of sending optical signals by using the optical amplitude modulation technology), and will not be repeated here.

The third light receiving module 222 includes a third photoelectric conversion unit 224 and the fourth trans-impedance amplifier TIA4. Accordingly, based on the third photoelectric conversion unit 224 and the fourth trans-impedance amplifier TIA4, a specific process of receiving optical signals by using the electric amplitude demodulation technology is similar to the related parts described above, and will not be repeated here.

In this embodiment, the third optical transceiving apparatus 220 realizes optical signal transceiving functions of the server node by using a linear amplifying technology, which has characteristics of low power consumption and low cost, and the structure thereof is simple.

Referring to FIG. 10 to FIG. 11, the third optical sending technology further includes: a third signal compensating technology, and the third optical receiving technology further includes: the third signal compensating technology, where the third signal compensating technology includes a linear amplifying technology and/or a clock data recovery technology.

Similarly, the third optical transceiving apparatus 220 can not only realize optical signal transceiving functions of the server node by using the linear amplifying technology, but also compensate the received-sent signal by using a simple direct driving technology and the clock data recovery technology, so that the third optical transceiving apparatus 220 can be applied to more types of server nodes and enhance the applicability of the active optical cable.

In an exemplary embodiment of the present specification, the third signal compensating technology may include the linear amplifying technology, may also include the clock data recovery technology, and may also include both the linear amplifying technology and the clock data recovery technology. When the third signal compensating technology includes both the linear amplification technology and the clock data recovery technology, similar to the first optical transceiving apparatus 120 and the second optical transceiving apparatus 130, the third optical transceiving apparatus 220 could include a plurality of third optical sending modules 221 and a plurality of third optical receiving modules 222. Based on the wavelength division multiplexing technology, the third optical transceiving apparatus 220 and the switch node may perform wavelength division multiplexing on signals by using a wavelength beam splitter/combiner and other devices, and signals of different branches can be processed by using the linear amplifying technology or the clock data recovery technology to meet processing requirements of multi-channel signals.

When the third signal compensating technology includes the linear amplifying technology, referring to FIG. 10, the third optical sending module 220 includes: a second continuous-time linear equalizer CTLE2 and a fifth driving amplifier DRV5, where the second continuous-time linear equalizer CTLE2 is configured to compensate a signal distortion of a third signal to be sent, and the fifth driving amplifier DRV5 is configured to improve the power of the third signal to be sent to improve a modulation efficiency of a third optical carrier.

The first optical receiving module includes: a sixth trans-impedance amplifier TIA6 and a second linear amplifier AMP2, where the sixth trans-impedance amplifier TIA6 is configured to perform, for a sixth input signal, a current-to-voltage conversion and an amplification for the first time, and the second linear amplifier AMP2 is configured to perform, for the sixth input signal after the amplification for the first time, an amplification for the second time, to obtain the third signal to be sent; and the sixth input signal is an input signal of the sixth trans-impedance amplifier.

The components (the second continuous-time linear equalizer CTLE2, the fifth driving amplifier DRV5, the sixth trans-impedance amplifier TIA6 and the second linear amplifier AMP2) achieving transceiving an optical signal based on the linear amplifying technology described in this embodiment are similar to the functions of the first continuous-time linear equalizer CTLE1, the first driving amplifier DRV1, the trans-impedance amplifier TIA and the first linear amplifier AMP1 described above, and will not be repeated here.

In this embodiment, the third optical transceiving apparatus 220 performs signal compensation based on the linear amplifying technology, which can improve the signal transceiving quality of the server node to a certain extent, so that the active optical cable 100 can be suitable for a general scene of the signal transmission environment of the server node, which is beneficial to improving the applicability of the active optical cable 100.

When the third signal compensating technology includes the clock data recovery technology, referring to FIG. 11, the third optical sending module 221 includes: a seventh signal processing unit and a sixth driving amplifier DRV6, where the sixth driving amplifier DRV6 is configured to increase the power of the third signal to be sent to improve a modulation efficiency of the third optical carrier, and the seventh signal processing unit is configured to regenerate and equalize the third signal to be sent based on the clock data recovery technology.

The third optical receiving module 222 includes: an eighth signal processing unit and a seventh trans-impedance amplifier TIA7, where the seventh trans-impedance amplifier TIA7 is configured to perform, for a seventh input signal, a current-to-voltage conversion and an amplification for the first time, and the eighth signal processing unit is configured to regenerate and equalize the seventh input signal after the amplification for the first time based on the clock data recovery technology, and where the seventh input signal is an input signal of the seventh trans-impedance amplifier TIA7.

Similarly, when based on the same signal processing technology, the seventh signal processing unit and the eighth signal processing unit can be integrated in one signal processing module 225.

Another exemplary embodiment of the present specification also provides an active optical cable, as shown in FIG. 12, which is applied to an optical communication network, and the optical communication network includes a server node and a switch node, and the active optical cable includes:
an optical communication medium 110, where optical communication medium 110 is used for transmitting an optical signal;
a fourth optical transceiving apparatus 310 and a fifth optical transceiving apparatus 320 respectively connected at two ends of the optical communication medium 110, where the fourth optical transceiving apparatus 310 is configured to connect to the server node, and the fifth optical transceiving apparatus 320 is configured to connect to the switch node.

The fourth optical transceiving apparatus 310 and the fifth optical transceiving apparatus 320 are different types of optical transceiving apparatuses, and the power consumption of the fourth optical transceiving apparatus 310 is less than the power consumption of the fifth optical transceiving apparatus 320.

Generally, the power consumption of optical transceiving apparatus is proportional to its signal processing performance. The signal processing performance of optical transceiving apparatus is stronger, the power consumption is higher, and the signal integrity after processing is better. In this embodiment, an active optical cable is provided to meet the different requirements of the server node and the switch node for signal integrity. As mentioned above, the signal integrity of the server node is easy to ensure, so the fourth optical transceiving apparatus 310 with low power consumption can be used as the optical signal transceiving device of the server node, while due to the long transmission required, the switch node needs to use the fifth optical transceiving apparatus 320 with high power consumption as the optical signal transceiving device. Therefore, the active optical cable provided by the embodiment of the present specification uses the optical transceiving apparatus with an asymmetric structure to realize the optical signal transceiving between the switch node and the server node, which reduces the power consumption and cost of the active optical cable while meeting the different requirements of the switch node and the server node.

In an exemplary embodiment of the present specification, the performance of the signal processing technology used by the fourth optical transceiving apparatus 310 is inferior to that used by the fifth optical transceiving apparatus 320. For example, when the signal processing technology used by the fourth optical transceiving apparatus 310 is the direct driving technology or the linear amplifying technology, the signal processing technology used by the fifth optical transceiving apparatus 320 can be the digital signal processing technology and/or the clock data recovery technology. When the signal processing technology used by the fourth optical transceiving apparatus 310 is the clock data recovery technology, the signal processing technology used by the fifth optical transceiving apparatus 320 can be the digital signal processing technology.

### Exemplary Optical Communication Network

An exemplary embodiment of the present specification also provides an optical communication network, as shown in FIG. 13, including:
a plurality of node devices, where the node devices are connected by active optical cables 100, and the node devices include server nodes 20 and switch nodes 30;
where the active optical cable 100 is the active optical cable 100 as described in any of the above embodiments.

In FIG. 13, a router is shown in addition to the switch node 30, and both the switch node 30 and the router are a kind of network switching device. These network switching devices can be interconnected, and the server nodes in the optical communication network can be interconnected through these network switching devices.

The architecture shown in FIG. 13 can be called a data center network. In this network structure, it can be divided into a server layer, an edge switch layer, an aggregate switch layer, a core switch layer, a router layer and an optical signal transmission layer. The active optical cable 100 is mainly used to realize the optical communication connection between the server node 20 and the switch node 30 in the server layer.

For a specific definition of each structure of all active optical cables 100, please refer to the relevant description in the “Exemplary Active Optical Cable” section above.

### Exemplary Method

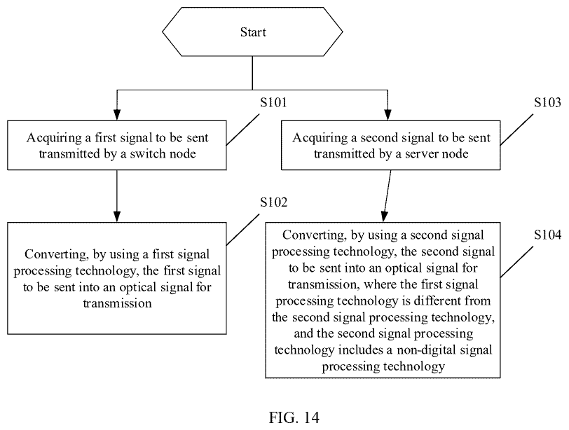

An exemplary embodiment of the present specification also provides an optical communication method, as shown in FIG. 14, including:

S101: acquiring a first signal to be sent transmitted by a switch node;

S102: converting, by using a first signal processing technology, the first signal to be sent into an optical signal for transmission;

S103: acquiring a second signal to be sent transmitted by a server node;

S104: converting, by using a second signal processing technology, the second signal to be sent into an optical signal for transmission, where the first signal processing technology is different from the second signal processing technology, and the second signal processing technology includes a non-digital signal processing technology.

The optical communication method provided by this embodiment depends on the active optical cable. For specific signal processing steps, please refer to the relevant description in the “Exemplary Active Optical Cable” section above.

It should be understood that although some steps in a flowchart of FIG. 14 are displayed in sequence as indicated by arrows, these steps are not necessarily executed in sequence as indicated by arrows. Unless explicitly stated in the present description, the execution of these steps is not strictly limited in order, and these steps can be executed in other orders. Moreover, at least a part of the steps in FIG. 14 may include multiple sub-steps or multiple stages, which may not necessarily be completed at the same time, but may be executed at different times, and the execution sequence of these sub-steps or stages may not necessarily be sequentially executed, but may be alternately or alternatively executed with other steps or at least a part of sub-steps or stages of other steps.

The technical features of the above embodiments can be combined arbitrarily. In order to make the description concise, not all possible combinations of the technical features in the above embodiments are described, however, as long as there is no contradiction between the combinations of these technical features, they should be considered as a scope recorded in the present specification.

The above-mentioned embodiments only express several implementations of the present specification, their descriptions are more specific and detailed, but they cannot be 10 understood as limiting a scope of the solutions provided by the embodiments of the present specification. It should be pointed out that for those skilled in the art, without departing from a concept of the present specification, several modifications and improvements can be made, which are within a protection scope of the present specification. Therefore, a protection scope of the patent of the present specification should be subject to the appended claims.

1. An active optical cable, applied to an optical communication network, wherein the optical communication network comprises a server node and a switch node, and the active optical cable comprises:
an optical communication medium;
a first optical transceiving apparatus and a second optical transceiving apparatus respectively connected at two ends of the optical communication medium, wherein the first optical transceiving apparatus is configured to connect to the server node, and the second optical transceiving apparatus is configured to connect to the switch node;
the first optical transceiving apparatus and the second optical transceiving apparatus use different signal processing technologies to perform a transceiving process on a photoelectric signal, and a signal processing technology used by the first optical transceiving apparatus comprises a non-digital signal processing technology.

2. The active optical cable according to claim 1, wherein the first optical transceiving apparatus comprises: a first optical sending device and a first optical receiving device; the second optical transceiving apparatus comprises: a second optical sending device and a second optical receiving device, and the photoelectric signal comprises: a first photoelectric signal and a second photoelectric signal;
wherein the first optical sending device is configured to perform a sending process on a first signal to be sent by using a first optical sending technology to obtain the first photoelectric signal, and the first optical sending technology comprises an optical amplitude modulation technology; and the first signal to be sent is a signal to be sent of the first optical sending device;
the first optical receiving device is configured to perform a receiving process on the second photoelectric signal by using a first optical receiving technology to obtain a first received signal, and the first optical receiving technology comprises an electric amplitude demodulation technology;
the second optical sending device is configured to perform a sending process on a second signal to be sent by using a second optical sending technology to obtain the second photoelectric signal, the second optical sending technology comprises an optical amplitude modulation technology and a first signal compensating technology, and the first signal compensating technology comprises a digital signal processing technology and/or a clock data recovery technology; and the second signal to be sent is a signal to be sent of the second optical sending device;
the second optical receiving device is configured to perform a receiving process on the first photoelectric signal by using a second optical receiving technology to obtain a second received signal, and the second optical receiving technology comprises the electric amplitude demodulation technology and the first signal compensating technology.

3. The active optical cable according to claim 2, wherein the first optical sending technology further comprises: a second signal compensating technology, and the first optical receiving technology further comprises: the second signal compensating technology, and the second signal compensating technology comprises a linear amplifying technology and/or the clock data recovery technology.

4. The active optical cable according to claim 3, wherein the first optical sending device comprises: a first signal compensator, and the first signal compensator comprises: a first continuous-time linear equalizer and a first driving amplifier, the first continuous-time linear equalizer is configured to compensate a signal distortion of a first signal to be sent, and the first driving amplifier is configured to improve power of the first signal to be sent to improve a modulation efficiency of a first optical carrier;
the first optical receiving device comprises: a second signal compensator, and the second signal compensator comprises: a first trans-impedance amplifier and a first linear amplifier, wherein the first trans-impedance amplifier is configured to perform, for a first input signal, a current-to-voltage conversion and an amplification for the first time, and the first linear amplifier is configured to perform, for the first input signal after the amplification for the first time, an amplification for the second time;
the second optical sending device comprises: a third signal compensator, and the third signal compensator comprises: a first signal process or and a second driving amplifier, wherein the second driving amplifier is configured to improve power of a second signal to be sent to improve a modulation efficiency of the second optical carrier, and the first signal processor is configured to regenerate and equalize the second signal to be sent based on the digital signal processing technology or the clock data recovery technology;
the second optical receiving device comprises: a fourth signal compensator, and the fourth signal compensator comprises: a second signal processor and a second trans-impedance amplifier, wherein the second trans-impedance amplifier is configured to perform, for a second input signal, a current-to-voltage conversion and an amplification for the first time, and the second signal processor is configured to regenerate and equalize the second input signal after the amplification for the first time based on the digital signal processing technology or the clock data recovery technology.

5. The active optical cable according to claim 3, wherein the first optical sending device comprises: a fifth signal compensator, and the fifth signal compensator comprises: a third signal processor and a third driving amplifier, wherein the third driving amplifier is configured to improve power of the first signal to be sent to improve a modulation efficiency of the first optical carrier, and the third signal processor is configured to regenerate and equalize the first signal to be sent based on the clock data recovery technology;
the first optical receiving device comprises: a sixth signal compensator, and the sixth signal compensator comprises: a fourth signal processor and a third trans-impedance amplifier, wherein the third trans-impedance amplifier is configured to perform, for a third input signal, a current-to-voltage conversion and an amplification for the first time, the fourth signal processor is configured to regenerate and equalize the third input signal after the amplification for the first time based on the clock data recovery technology;
the second optical sending device comprises: a seventh signal compensator, and the seventh signal compensator comprises: a fifth signal processor and a fourth driving amplifier, wherein the fourth driving amplifier is configured to improve power of a second signal to be sent to improve a modulation efficiency of the second optical carrier, and the fifth signal processor is configured to regenerate and equalize the second signal to be sent based on the digital signal processing technology; and the second signal to be sent is a signal to be sent of the second optical sending device;
the second optical receiving device comprises: an eighth signal compensator, and the eighth signal compensator comprises:
a sixth signal processor and a fourth trans-impedance amplifier, wherein the fourth trans-impedance amplifier is configured to perform, for a fourth input signal, a current-to-voltage conversion and an amplification for the first time, and the sixth signal processor is configured to regenerate and equalize the fourth input signal after the amplification for the first time based on the digital signal processing technology.

6. The active optical cable according to claim 1, wherein the first optical transceiving apparatus further comprises: a first identifier, wherein the first identifier is used for indicating that the first optical transceiving apparatus is configured to connect to the server node;
the second optical transceiving apparatus further comprises: a second identifier, wherein the second identifier is used for indicating that the second optical transceiving apparatus is configured to connect to the switch node.

7. An active optical cable, applied to an optical communication network, wherein the optical communication network comprises a server node and a switch node, the switch node comprises an optical device, and the active optical cable comprises:
an optical communication medium;
an optical fiber connector and a third optical transceiving apparatus respectively connected at two ends of the optical communication medium, wherein the optical fiber connector is configured to connect to the optical device, and the third optical transceiving apparatus is configured to connect to the server node;
the optical fiber connector is configured to perform an optical signal transceiving process for the switch node;
the third optical transceiving apparatus is configured to perform a transceiving process on a third photoelectric signal by using a non-digital signal processing technology.

8. The active optical cable according to claim 7, wherein the switch node further comprises an integrated circuit chip, and the integrated circuit chip and the optical device are packaged in the switch node through a co-packaged optics technology, an on-board optics technology or a near-packaged optics technology.

9. The active optical cable according to claim 7, wherein the third optical transceiving apparatus comprises: a third optical sending device and a third optical receiving device;
wherein the third optical sending device is configured to perform a sending process on a third signal to be sent by using a third optical sending technology to obtain a third photoelectric signal, the third optical sending technology comprises an optical amplitude modulation technology, and the third signal to be sent is a signal to be sent of the third optical sending device;
third optical receiving device is configured to perform a receiving process on the third photoelectric signal by using a third optical receiving technology, the third optical receiving technology comprises an electric amplitude demodulation technology.

10. The active optical cable according to claim 9, wherein the third optical sending technology further comprises: a third signal compensating technology, and the third optical receiving technology further comprises: the third signal compensating technology, wherein the third signal compensating technology comprises a linear amplifying technology and/or a clock data recovery technology.

11. An active optical cable, applied to an optical communication network, wherein the optical communication network comprises a server node and a switch node, and the active optical cable comprises:
an optical communication medium;
a fourth optical transceiving apparatus and a fifth optical transceiving apparatus respectively connected at two ends of the optical communication medium, wherein the fourth optical transceiving apparatus is configured to connect to the server node, and the fifth optical transceiving apparatus is configured to connect to the switch node;
wherein the fourth optical transceiving apparatus and the fifth optical transceiving apparatus are different types of optical transceiving apparatuses, and a power consumption of the fourth optical transceiving apparatus is less than a power consumption of the fifth optical transceiving apparatus.

12. An optical communication network, comprising:
a plurality of node devices, wherein the node devices are connected by active optical cables, and the node devices comprise a server node and a switch node;
the active optical cable is the active optical cable according to claim 1.

13. (canceled)

14. The active optical cable according to claim 2, wherein the first optical transceiving apparatus further comprises: a first identifier, wherein the first identifier is used for indicating that the first optical transceiving apparatus is configured to connect to the server node;
the second optical transceiving apparatus further comprises: a second identifier, wherein the second identifier is used for indicating that the second optical transceiving apparatus is configured to connect to the switch node.

15. The active optical cable according to claim 3, wherein the first optical transceiving apparatus further comprises: a first identifier, wherein the first identifier is used for indicating that the first optical transceiving apparatus is configured to connect to the server node;
the second optical transceiving apparatus further comprises: a second identifier, wherein the second identifier is used for indicating that the second optical transceiving apparatus is configured to connect to the switch node.

16. The active optical cable according to claim 4, wherein the first optical transceiving apparatus further comprises: a first identifier, wherein the first identifier is used for indicating that the first optical transceiving apparatus is configured to connect to the server node;
the second optical transceiving apparatus further comprises: a second identifier, wherein the second identifier is used for indicating that the second optical transceiving apparatus is configured to connect to the switch node.

17. The active optical cable according to claim 5, wherein the first optical transceiving apparatus further comprises: a first identifier, wherein the first identifier is used for indicating that the first optical transceiving apparatus is configured to connect to the server node;
the second optical transceiving apparatus further comprises: a second identifier, wherein the second identifier is used for indicating that the second optical transceiving apparatus is configured to connect to the switch node.

18. An optical communication network, comprising:
a plurality of node devices, wherein the node devices are connected by active optical cables, and the node devices comprise a server node and a switch node;
the active optical cable is the active optical cable according to claim 7.

19. An optical communication network, comprising:
a plurality of node devices, wherein the node devices are connected by active optical cables, and the node devices comprise a server node and a switch node;
the active optical cable is the active optical cable according to claim 11.
